(19) United States
(12) Patent Application Publication
(10) Pub. No.: US 2024/0375191 A1
(43) Pub. Date: Nov. 14, 2024

(54) DRILL

(71) Applicant: OSG CORPORATION, Toyokawa-shi, Aichi (JP)

(72) Inventor: Hiroyasu MAKINO, Toyokawa-shi, Aichi (JP)

(21) Appl. No.: 18/689,515

(22) PCT Filed: Sep. 6, 2021
(86) PCT No.: PCT/JP2021/032569

§ 371 Date: Mar. 6, 2024

(51) Int. Cl. B23B 51/02

(52) U.S. Cl. CPC B23B 51/02; B23B 2251/404

(57) ABSTRACT

A drill includes a drill main body to be rotated around a shaft center, discharge flutes provided in a helical shape in an outer peripheral surface, a cutting edge formed at a ridge section between an inner face, of the discharge flute, and a flank of the drill main body at a leading end portion, a thinning edge provided at the leading end portion of the drill main body, a thinning face being a rake face of the thinning edge, and connecting the thinning edge with the discharge flute, and a gash portion connected to the thinning face, a ridge line between the gash portion and the flank extending in a circular arc shape from an inner end of the thinning edge, and being connected to the discharge flute. The gash portion is connected to the discharge flute while twisting along a helix angle of the discharge flute.

### TECHNICAL FIELD

The present invention relates to a drill.

### BACKGROUND ART

In known art, a drill is known in which a thinning edge and an R gash are formed at a leading end portion of a drill main body (refer to Patent Literature 1, for example). The thinning edge is formed at the leading end portion of the drill by applying a thinning process, on an inner end side of a cutting edge. A ridge line of the R gash that is formed between the R gash and a flank extends in a circular arc shape from the inner end side of the thinning edge toward an outer peripheral surface of the drill. A discharge flute is provided in the outer peripheral surface of the drill main body. The discharge flute is provided in a helical shape from the leading end portion of the drill main body toward a base end portion of the drill main body.

### CITATION LIST

### Patent Literature

Patent Literature 1: Japanese Patent Application Publication No. 2016-59999 A

### SUMMARY OF INVENTION

### Problems that Invention is to Solve

In the above-described drill, a corner portion is formed at a section connecting the R gash and the discharge flute. For example, when processing an aluminum alloy or the like, since the aluminum alloy is a light and soft material, when cut using the drill, small and short chips are likely to be generated. In this case, there is a possibility that a chip discharge performance of the drill may deteriorate as a result of the chips becoming caught up on the corner portion.

An object of the present invention is to provide a drill capable of improving a chip discharge performance.

According to an aspect of the present invention, a drill comprising: a drill main body to be rotated around a shaft center; a plurality of discharge flutes provided in a helical shape in an outer peripheral surface from a leading end portion toward a rear end portion of the drill main body; a cutting edge formed at a ridge section between an inner face, of the discharge flute, oriented toward a rotation direction side of the drill main body and a flank of the drill main body at the leading end portion; a thinning edge provided at the leading end portion of the drill main body, and extending from an inner end of the cutting edge toward a chisel, the chisel being a leading end section of the drill main body; a thinning face being a rake face of the thinning edge, and connecting the thinning edge with the discharge flute; and a gash portion connected to the thinning face, a ridge line between the gash portion and the flank extending in a circular arc shape from an inner end of the thinning edge, and being connected to the discharge flute, wherein the gash portion is connected to the discharge flute while twisting along a helix angle of the discharge flute.

The drill according to the present aspect can cause a section connecting the gash portion and the discharge flute to be smooth, as a result of the gash portion connecting to the discharge flute while twisting along the helix angle of the discharge flute. Thus, the drill can improve a chip discharge performance.

In the present aspect, the gash portion may be connected to the discharge flute while twisting in an opposite direction to the rotation direction, the further from the leading end portion side to the base end portion side. The drill can cause the section connecting the gash portion and the discharge flute to be smooth and can smoothly discharge chips without the chips clogging.

In the present aspect, a helix angle of the gash portion may be in a range of 0° to −6°, using the helix angle of the discharge flute as a reference. The drill can cause the section connecting the gash portion and the discharge flute to be smooth and can smoothly discharge chips without the chips clogging.

In the present aspect, when a drill diameter is D, a length of the gash portion in a shaft center direction of the drill may be in a range of 0.5 D to 1.4 D. The drill can improve the chip discharge performance while securing rigidity.

In the present aspect, the gash portion may extend in a circular arc shape from the inner end of the thinning edge toward the outer side of the drill main body in a radial direction, and may be connected to the outer peripheral surface of the drill main body. The drill can cause the gash portion to be larger, by causing the gash portion to be connected to the outer peripheral surface of the drill main body.

In the present aspect, a body clearance may be provided in the outer peripheral surface, and the gash portion may extend in a circular arc from the inner end of the thinning edge toward the outer side of the drill main body in the radial direction and may be connected to the body clearance. The drill can cause the gash portion to be larger, by causing the gash portion to be connected to the body clearance of the drill main body, while reducing a frictional resistance with a work material, using the body clearance.

In the present aspect, the drill may be provided with three of the cutting edges. The drill, as the three-edged drill, can obtain similar effects as the drill of the above-described aspects.

In the present aspect, a surface of at least the leading end portion of the drill main body may be coated with DLC. The drill can improve a deposition welding resistance of the leading end portion of the drill main body.

In the present aspect, the drill may be configured to cut an aluminum alloy. Since the aluminum alloy is a light and soft material, when cut using the drill, small and short chips are likely to be generated.

The drill can inhibit the chips from clogging at the section connecting the gash portion and the discharge flute, and thus can favorably cut the aluminum alloy.

### BRIEF DESCRIPTION OF THE DRAWINGS

FIG. 1 is a side view of a drill 1.

FIG. 2 is a perspective view of the drill 1.

FIG. 3 is a front view of the drill 1.

FIG. 4 is a table showing results of an Evaluation Test 1.

FIG. 5 is a table showing results of an Evaluation Test 2.

FIG. 6 is a graph showing results of an Evaluation Test 3.

FIG. 7 is a graph showing results of an Evaluation Test 4.

### MODES FOR CARRYING OUT THE INVENTION

An embodiment of the present invention will be described. The present invention is not limited to the following embodiment, and design changes can be made as appropriate. For descriptive clarity, there are locations in the drawings showing dimensional ratios that are different to actual dimensional ratios as necessary. The present invention is not interpreted as being limited to the shape thereof.

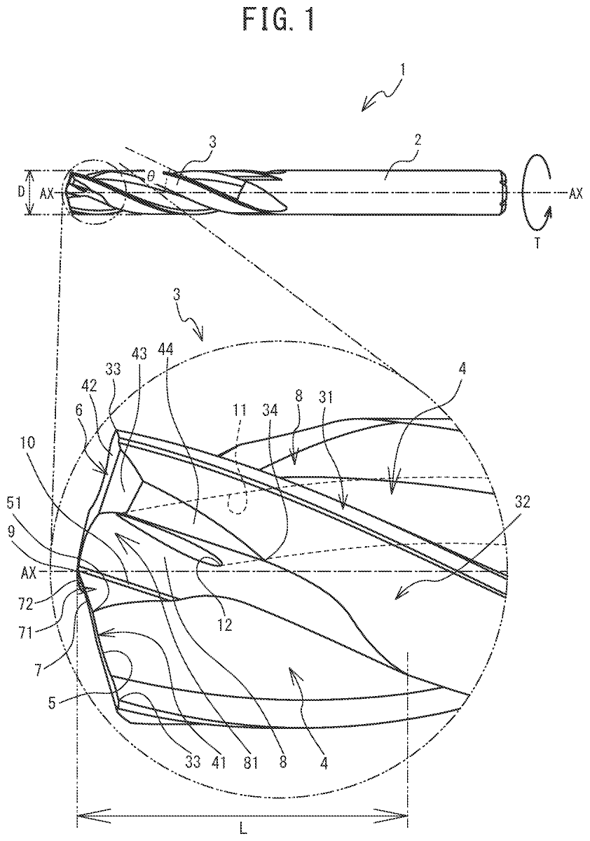

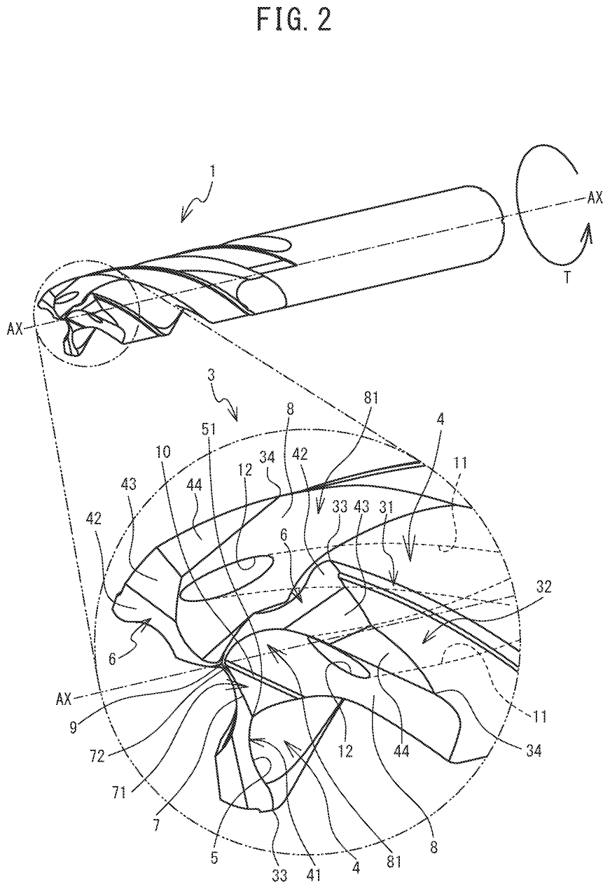

The configuration of a drill 1 will be explained with reference to FIG. 1 to FIG. 3. As shown in FIG. 1 and FIG. 2, the drill 1 is a three-edged drill and is used for cutting an aluminum alloy, for example. The drill 1 is formed from a hard material, such as a cemented carbide, high speed tool steel (high speed steel), or the like. The drill 1 is provided with a shank 2 and a body 3. The shank 2 and the body 3 are an example of a “drill main body” of the present invention. The shank 2 is a portion that is mounted to a drive shaft of a machine tool, and is the rear end side of the drill 1. The body 3 extends along a shaft center AX from the front end of the shank 2.

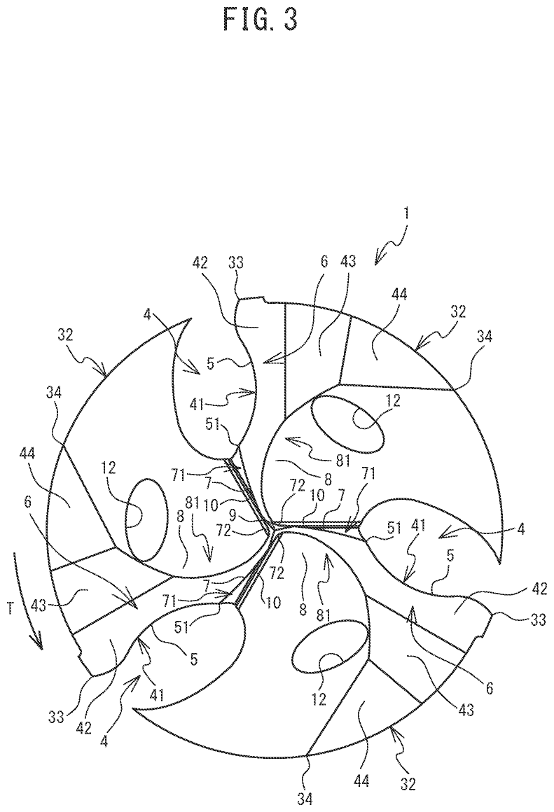

Three discharge flutes 4 having a predetermined helix angle θ are formed in a helical shape in an outer peripheral surface 31 of the body 3. The helix angle θ may be changed as appropriate. The discharge flutes 4 discharge chips. Each of the discharge flutes 4 opens at the leading end portion of the body 3 and a cutting edge 5 is formed at the open portion. The drill 1 cuts a work material (not shown in the drawings) using the cutting edges 5, by rotating around the shaft center AX, and forms a machining hole while discharging the chips at the discharge flutes 4. At a time of machining, a rotation direction T of the drill 1 is a counterclockwise direction in a front view (refer to FIG. 3). The machine tool (not shown in the drawings) cuts the work material by rotating the drive shaft, to which the drill 1 is mounted, in the rightward direction.

The discharge flute 4 is provided with an inner face 41. The cutting edge 5 is formed at a ridge section at which the inner face 41 oriented toward the rotation direction T side and a flank 6 intersect with each other. The cutting edge 5 is substantially S-shaped in a front view. Of the inner face 41, the inner face 41 on the cutting edge 5 side is a rake face, and scoops up the chips cut by the cutting edge 5 and causes the chips to flow to the discharge flute 4.

Of the inner face 41, a section at which the inner face 41 on the cutting edge 5 side and the outer peripheral surface 31 of the body 3 intersect with each other is a leading edge 33. A body clearance 32 is provided between the leading edges 33 that are adjacent to each other in a circumferential direction. The body clearance 32 is formed further to an inner side in a radial direction than the outer peripheral surface 31, and has a smaller diameter than a drill diameter D. The drill diameter D may be changed as appropriate. By including the body clearance 32, the drill 1 can reduce frictional resistance due to contact between an inner surface of the machining hole and the outer peripheral surface 31 of the body 3 when forming the machining hole, and can suppress heat generation and machining torque. Of the inner face 41, a section at which the inner face 41 on the opposite side from the cutting edge 5 and the body clearance 32 intersect with each other is a heel 34.

A chisel 9 is provided at a center portion of the leading end portion of the drill 1. A thinning process is performed on the leading end portion of the drill 1. The thinning process is processing to thin the web thickness in the vicinity of the chisel 9. For example, the thinning process forms a thinning edge 7 by cutting into the open portion of the discharge flute 4 while rotating a grinding stone, from an inner end 51 of the cutting edge 5 to the side of the chisel 9. The inner end 51 of the cutting edge 5 is an end portion on the inner side on the shaft center AX side. The thinning edge 7 extends in a circular arc shape, in a front view, from the inner end 51 toward the chisel 9. As a result of forming the thinning edge 7, a thinning face 71 is formed at the leading end portion of the drill 1. The thinning face 71 is a rake face oriented toward the side of the rotation direction T of the thinning edge 7.

After forming the thinning edge 7, the thinning process further cuts in while relatively moving the grinding stone with respect to the drill 1 toward the heel 34 side, and forms a gash portion 8. The gash portion 8 is provided with a gash face 81. The gash face 81 is a curved surface that is recessed toward the inner side. A length of the gash portion 8 in the shaft center AX direction of the drill 1 is L (refer to FIG. 1). The length L of the gash portion 8 is machined to be within a range of 0.5 D to 1.4 D in relation to the drill diameter D, for example. A ridge line at which the gash face 81 and the flank 6 intersect each other extends in a circular arc shape from an inner end 72 of the thinning edge 7 toward the outer peripheral surface 31, and connects to the body clearance 32. The inner end 72 of the thinning edge 7 is an end portion on the inner side on the shaft center AX side. The gash portion 8 is connected to the body clearance 32 of the body 3, and thus, can secure a larger capacity of a chip pocket. The chip pocket is a space accommodating the chips cut by the thinning edge 7. Thus, the drill 1 can smoothly dispatch the chips without causing clogging in the discharge flute 4.

A circular arc groove 10 is formed at a section connecting the gash face 81 and the thinning face 71 with each other. The circular arc groove 10 extends in a straight line from the vicinity of the chisel 9 toward the discharge flute 4, and a cross section in an extending direction has a circular arc shape. The circular arc groove 10 can smoothly push the chips cut by the thinning edge 7 and scooped up by the thinning face 71 to the gash portion 8. Thus, the drill 1 can reduce cutting resistance and obtain a stable chip shape.

The gash portion 8 is connected to the discharge flute 4 while twisting in an opposite direction to the rotational direction T from the leading end portion side to the base end portion side. As an example, the gash portion 8 is machined to twist within a range of 0° to −6° with respect to the helix angle θ of the discharge flute 4. Thus, the gash portion 8 is smoothly connected to the discharge flute 4.

At the time of machining the work material, the chips are generated by the thinning edge 7 in the vicinity of the chisel 9 cutting into the work material. The chips are scooped up by the thinning face 71, and pushed into the gash portion 8 via the circular arc groove 10. The chips are rounded and curled by the gash face 81, are cut by the leading edge 33, and are dispatched to the discharge flute 4. The gash portion 8 of the present application is smoothly connected to the discharge flute 4. In this way, the gash portion 8 is able to smoothly discharge the chips to the discharge flute 4.

Three coolant passages 11 penetrate the inside of the drill 1 in a helical shape from the rear end of the shank 2 to the leading end of the body 3, along the discharge flutes 4 (refer to FIG. 3). Each of the coolant passages 11 opens at the gash portion 8, and forms an oil hole 12. At the time of machining, a cutting oil is supplied into the coolant passage 11, and is ejected from the oil hole 12 toward a machining position of the work material. In this way, the drill 1 reduces the cutting resistance and suppresses the heat generation and the machining torque. The chips flow through the discharge flutes 4 together with the cutting oil and are smoothly discharged.

The flank 6 is a surface avoiding contact with a processing surface of the work material. The flank 6 is provided with a second flank 42, a third flank 43, and a fourth flank 44, in order toward the opposite side from the rotation direction T. The second flank 42 is positioned furthest to the front in the rotation direction T, and extends from the chisel 9 to the outer peripheral surface 31. The third flank 43 is bent and curves to the rear end side from a substantially central portion, in the radial direction, of the ridge line on the opposite side from the cutting edge 5 of the second flank 42. The third flank 43 then extends to the opposite side from the rotation direction T, and becomes narrower the further toward the leading end side. The fourth flank 44 is bent and curves to the rear end side from a ridge line on the opposite side to the second flank 42 side of the third flank 43. The fourth flank 44 then extends in the opposite direction from the rotation direction T, and becomes narrower the further toward the leading end side. The leading end portion of the fourth flank 44 is the heel 34.

In the drill 1 provided with the above-described configuration, it is preferable that the surface of at least the leading end portion of the body 3 be coated with Diamond-Like Carbon (DLC). DLC is a generic name for a thin film made of a substance having, as its main component, carbon having carbon-carbon bonds of both diamond and graphite (black lead). In this way, the drill 1 can improve deposition welding resistance of the leading end portion of the body 3.

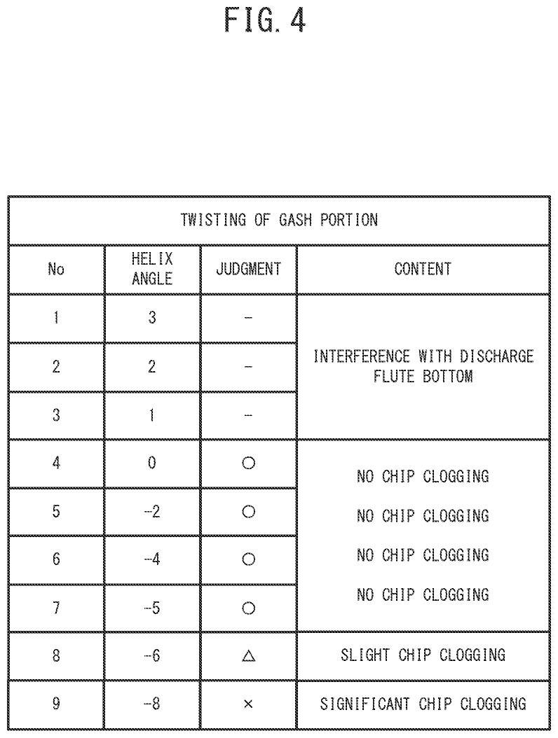

An Evaluation Test 1 for evaluating the chip discharge performance will be described with reference to FIG. 4. In Evaluation Test 1, the chip discharge performance in the drill 1 was tested when changing a helix angle of the gash portion 8. The helix angle of the gash portion 8 was adjusted within a range of 3° to −8°, using the helix angle θ of the discharge flute 4 as a reference, and nine helix angles were tested. A No. 1 of the drills 1 has a helix angle of 3°, a No. 2 of the drills 1 has a helix angle of 2°, a No. 3 of the drills 1 has a helix angle of 1°, a No. 4 of the drills 1 has a helix angle of 0°, a No. 5 of the drills 1 has a helix angle of −2°, a No. 6 of the drills 1 has a helix angle of −4°, a No. 7 of the drills 1 has a helix angle of −5°, a No. 8 of the drills 1 has a helix angle of −6°, and a No. 9 of the drills 1 has a helix angle of −8°. The drill diameter D of the drill 1 was φ12.0. Note that, for No. 1 to No. 3 of the drills 1, a desired shape of the drill 1 could not be realized due to interference between the gash portion 8 and a flute bottom of the drill 1 when forming the gash portion 8.

In machining conditions for Evaluation Test 1, a cutting speed was 377 m/min. A drive shaft rotation speed was 10000/min⁻¹. A feed amount was 10000 mm/min. A feed amount per rotation of the drill 1 was set to 1 mm/rev. A machining method was set to non-step machining. A machining depth of the work material was set to 90 mm. Aluminum casting alloy AC4C was used as the work material.

Since the desired drill could not be realized, the chip discharge performance was not tested for No. 1 to No. 3 of the drills 1. Thus, cutting of the work material was conducted using No. 4 to No. 9 of the drills 1, and the chip discharge performance was tested. The discharge performance test results were judged using three evaluation levels of ◯, Δ, and x. When there was no clogging of the chips, the judgment was ◯. When there was some clogging of the chips but the cutting was possible, the judgment was Δ. When there was significant clogging of the chips and the cutting was not possible, the judgment was x.

No. 1 to No. 3 of the drills 1 were not tested and thus the judgment was not possible. For No. 4 to No. 7 of the drills 1, clogging of the chips did not occur and the cutting was possible. Thus, the judgment result was ◯. For No. 8 of the drills 1, slight clogging of the chips occurred, but the cutting was possible without any problem. Thus, the judgment result was Δ. For No. 9 of the drills 1, clogging of the chips occurred and the cutting was not possible. Thus, the judgment result was x.

According to the above-described evaluation test results, the helix angle of the gash portion 8 was verified to be ◯ within a range of 0° to −6°, using the helix angle θ of the discharge flute 4 as the reference.

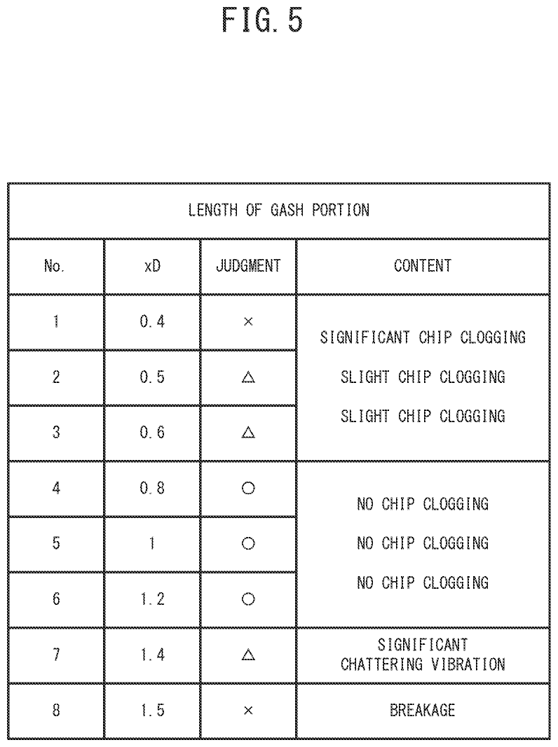

An Evaluation Test 2 for evaluating the chip discharge performance will be described with reference to FIG. 5. In Evaluation Test 2, the chip discharge performance was tested when changing the length L of the gash portion 8. When performing Evaluation Test 2, eight of the drills 1, namely, No. 1 to No. 8 having the different lengths L of the gash portion 8 were prepared. The length L of the gash portion 8 changed between 0.4 D to 1.5 D in relation to the drill diameter D. The length L of the gash portion 8 of No. 1 is 0.4 D, the length L of the gash portion 8 of No. 2 is 0.5 D, the length L of the gash portion 8 of No. 3 is 0.6 D, the length L of the gash portion 8 of No. 4 is 0.8 D, the length L of the gash portion 8 of No. 5 is 1 D, the length L of the gash portion 8 of No. 6 is 1.2 D, the length L of the gash portion 8 of No. 7 is 1.4 D, and the length L of the gash portion 8 of No. 8 is 1.5 D. The helix angle of the gash portion 8 was common to the eight drills 1, and was −2° using the helix angle θ of the discharge flute 4 as the reference for example. Note that the other machining conditions and the like were the same as the conditions for Evaluation Test 1.

Cutting of the work material was performed using No. 1 to No. 8 of the drills 1, and the chip discharge performance was tested. The discharge performance test results were judged using the three evaluation levels of ◯, Δ, and x. When there was no clogging of the chips, the judgment was ◯. When there was some clogging of the chips but the cutting was possible, the judgment was Δ. When there was significant clogging of the chips and the cutting was not possible, the judgment was x.

For No. 1 of the drills 1, significant clogging of the chips occurred, and cutting was not possible. Thus, the judgement was x. For No. 2 and No. 3 of the drills 1, even though some clogging of the chips occurred, cutting was possible without any problem. Thus, the judgment was Δ. For No. 4 to No. 6 of the drills 1, no clogging of the chips occurred and cutting was possible. Thus, the judgment was ◯. For No. 7 of the drills 1, although chattering vibration occurred, there was no clogging of the work piece, and cutting was possible. Thus, the judgment was Δ. For No. 8 of the drills 1, breakage occurred. Thus, the judgment was x.

According to the above-described test results, it was verified that, when the drill diameter is D, the length L of the gash portion 8 in the shaft center AX direction of the drill 1 is preferably within a range of 0.5 D to 1.4 D.

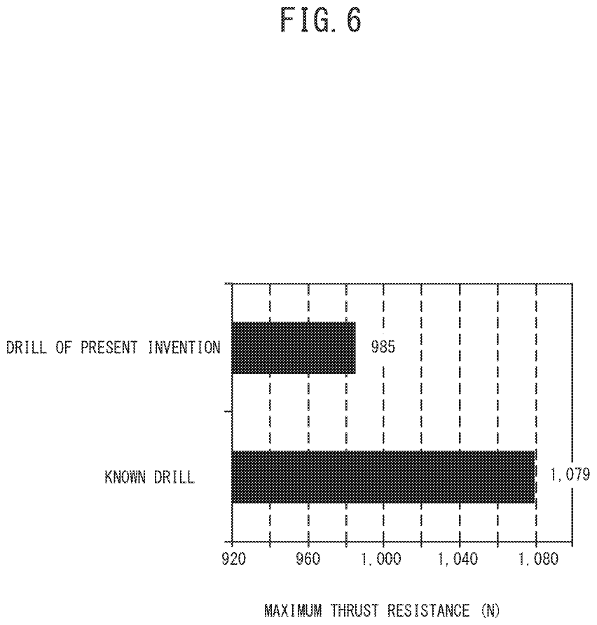

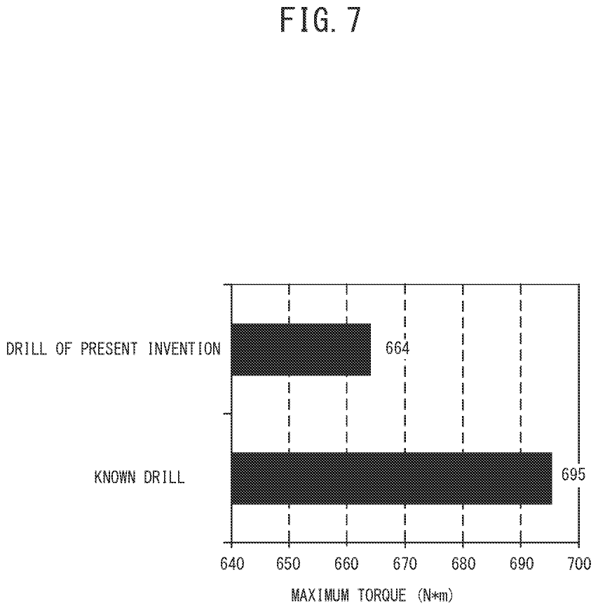

Evaluation Tests 3 and 4 for evaluating a durability performance of the drill 1 will be described with reference to FIG. 6 and FIG. 7. Evaluation Test 3 measured a maximum thrust resistance (N) when machining the work material using the drill 1 of the present invention, and compared the drill 1 to a known drill. The thrust resistance refers to the cutting resistance acting in an opposite direction to a direction of movement of the drill 1. The cutting resistance is generated in a perpendicular direction with respect to the cutting edge 5 of the drill 1, and the receiving of that cutting resistance in the axial direction is the thrust resistance. Evaluation Test 4 measured a maximum cutting torque (N) when machining the work material using the drill 1 of the present invention, and compared the drill 1 to the known drill. Note that the known drill is a drill having a corner portion between a gash face and a discharge flute.

In Evaluation Tests 3 and 4, the drill diameter D of the drill 1 was φ9.8. The helix angle of the gash portion 8 of the drill 1 was −2° using the helix angle θ of the discharge flute 4 as the reference. The length L of the gash portion 8 was 1 D. The machining depth of the work material was set to 50 mm. The cutting speed was 298 m/min. The drive shaft rotation speed was 9700/min⁻¹. The feed amount was 8730 mm/min. The feed amount per rotation of the drill 1 was 0.9 mm/rev. Aluminum die-cast ADC12 was used as the work material.

As shown in FIG. 6, in contrast to the maximum thrust resistance of the known drill being 1079 (N), the maximum thrust resistance of the drill 1 of the present invention was 985 (N). Thus, it was verified that the drill 1 of the present invention can reduce the maximum thrust resistance incurred during the machining, compared to the known drill.

As shown in FIG. 7, in contrast to the maximum torque of the known drill being 695 (N*m), the maximum torque of the drill 1 of the present invention was 664 (N*m). Thus, it was verified that the drill 1 of the present invention can reduce the maximum torque incurred during the machining, compared to the known drill.

As described above, the drill 1 according to the present embodiment is provided with the body 3, the plurality of discharge flutes 4, the cutting edge 5, the thinning edge 7, and the gash portion 8. The body 3 rotates around the shaft center AX. The plurality of discharge flutes 4 are provided in the helical shape in the outer peripheral surface 31 from the leading end portion toward the base end portion of the body 3. The cutting edge 5 is formed at the ridge section at which the inner face of the discharge flute 4 oriented toward the rotation direction T side of the body 3 and the flank 6 of the body 3 intersect with each other at the leading end portion. The thinning edge 7 is provided at the leading end portion of the body 3, and extends from the inner end of the cutting edge 5 toward the chisel 9 that is the leading end section of the body 3. The thinning face 71 is the rake face of the thinning edge 7, and connects the thinning edge 7 with the discharge flute 4. The gash portion 8 is connected to the thinning face 71, and the ridge line between the gash portion 8 and the flank 6 extends in the circular arc shape from the inner end of the thinning edge 7 and is connected to the discharge flute 4. The gash portion 8 is connected to the discharge flute 4 while twisting along the helix angle θ of the discharge flute 4.

As a result of the gash portion 8 being connected to the discharge flute 4 while twisting along the helix angle θ of the discharge flute 4, the drill 1 can smoothly connect the section connecting the gash portion 8 and the discharge flute 4. Thus, the drill 1 can improve the chip discharge performance.

The gash portion 8 is connected to the discharge flute 4 while twisting in the opposite direction to the rotation direction T, the further from the leading end side toward the base end side. The drill 1 can cause the section connecting the gash portion 8 and the discharge flute 4 to be smooth, and can smoothly discharge the chips without the chips clogging.

The helix angle of the gash portion 8 is within the range from 0° to −6°, using the helix angle θ of the discharge flute 4 as the reference. The drill 1 can cause the section connecting the gash portion 8 and the discharge flute 4 to be smooth, and can smoothly discharge the chips without the chips clogging.

When the drill diameter is D, the length L of the gash portion 8 in the shaft center direction of the drill 1 is within a range of 0.5 D to 1.4 D. The drill 1 can improve the chip discharge performance while securing the rigidity.

The gash portion 8 extends in the circular arc shape from the inner end of the thinning edge 7, and is connected to the body clearance 32 further to the inner side in the radial direction than the outer peripheral surface 31 of the body 3. As a result of causing the gash portion 8 to be connected to the body clearance 32 of the body 3, the drill 1 can make the gash portion 8 larger while reducing the frictional resistance with the work material, using the body clearance 32.

The drill 1 is provided with the three cutting edges 5. The drill 1, as the three-edged drill, can improve the chip discharge performance.

The surface of at the least the leading end portion of the body 3 is coated with DLC. The drill 1 can improve the deposition welding resistance of the leading end portion of the body 3.

The drill 1 is configured to cut the aluminum alloy. The aluminum alloy is a light and soft material, and thus, when cut using the drill 1, small and short chips are likely to be generated. The drill 1 can inhibit the chips from clogging at the section connecting the gash portion 8 and the discharge flute 4, and thus can favorably cut the aluminum alloy.

Note that the present invention is not limited to the above-described embodiment, and various modifications are possible. The drill 1 is the drill for machining the soft work material, such as the aluminum alloy or the like, but may be used for machining a hard work material.

The material of the drill 1 is not limited. The surface of at least the leading end portion of the body 3 is coated with DLC, but the outer peripheral surface 31 may also be coated. The body 3 need not necessarily be coated with DLC.

The drill 1 is the three-edged drill, but may be a two-edged drill, or may be a four-edged drill or more. The drill 1 may also be employed as a so-called long drill.

The gash portion 8 may be formed using a method other than the thinning process. The gash portion 8 is the circular arc shape, but may be a straight line shape. The thinning edge 7 need not necessarily be formed.

The coolant passage 11 extends in the helical shape from the rear end portion of the shank 2 toward the leading end portion of the body 3, but need not necessarily be the helical shape, and may be a straight line shape, for example. The three circular arc grooves 10 are provided at the leading end portion of the body 3, but the circular arc grooves 10 may be omitted.

The flank 6 is not limited to being configured by the second flank 42, the third flank 43, and the fourth flank 44, but the third flank 43 and the fourth flank 44 need not necessarily be provided.

The body clearance 32 provided at the outer peripheral surface 31 of the drill 1 may be omitted. In this case, the gash portion 8 may be connected to the outer peripheral surface 31 of the body 3.

1. A drill comprising:
a drill main body to be rotated around a shaft center;
a plurality of discharge flutes provided in a helical shape in an outer peripheral surface from a leading end portion toward a rear end portion of the drill main body;
a cutting edge formed at a ridge section between an inner face, of the discharge flute, oriented toward a rotation direction side of the drill main body and a flank of the drill main body at the leading end portion;
a thinning edge provided at the leading end portion of the drill main body, and extending from an inner end of the cutting edge toward a chisel, the chisel being a leading end section of the drill main body;
a thinning face being a rake face of the thinning edge, and connecting the thinning edge with the discharge flute; and
a gash portion connected to the thinning face, a ridge line between the gash portion and the flank extending in a circular arc shape from an inner end of the thinning edge, and being connected to the discharge flute, wherein
the gash portion is connected to the discharge flute while twisting along a helix angle of the discharge flute,
when viewing the drill main body from the side view, a boundary between the outer peripheral surface and the gash portion extends from the leading end portion side toward the rear end portion side of the main body, bulges in an arc-shape toward the outer peripheral surface side at the leading end portion side, and bulges in an arc-shape toward the gash portion side at the rear end portion side.

2. The drill according to claim 1, wherein
the gash portion is connected to the discharge flute while twisting in an opposite direction to the rotation direction, the further from the leading end portion side to the base end portion side.

3. The drill according to claim 1, wherein
a helix angle of the gash portion is in a range of 0° to −6°, using the helix angle of the discharge flute as a reference.

4. The drill according to claim 1, wherein
when a drill diameter is D, a length of the gash portion in a shaft center direction of the drill is in a range of 0.5 D to 1.4 D.

5. The drill according to claim 1, wherein
the gash portion extends in a circular arc shape from the inner end of the thinning edge toward the outer side of the drill main body in a radial direction, and is connected to the outer peripheral surface of the drill main body.

6. The drill according to claim 5, wherein
a body clearance is provided in the outer peripheral surface, and
the gash portion extends in a circular arc from the inner end of the thinning edge toward the outer side of the drill main body in the radial direction, and is connected to the body clearance.

7. The drill according to claim 1, wherein
the drill is provided with three of the cutting edges.

8. The drill according to claim 1, wherein
the surface of at least the leading end portion of the drill main body is coated with DLC.

9. The drill according to claim 1, wherein
the drill is configured to cut an aluminum alloy.
